(19) United States
(12) Patent Application Publication
(10) Pub. No.: US 2003/0099861 A1
(43) Pub. Date: May 29, 2003

(54) Efficient red organic electroluminescent devices

(76) Inventors: Shuit -Tong Lee, Kowloon (HK); Liang-Sun Hung, Kowloon (HK); Chun-Sing Lee, Kowloon (HK); Xiao-Qin Lin, Kowloon (HK); Xiao-Hong Zhang, Kowloon (HK)

Correspondence Address: MERCHANT & GOULD PC, P.O. BOX 2903, MINNEAPOLIS, MN, 55402-0903, US

(21) Appl. No.: 10/001,243

(22) Filed: Nov. 1, 2001

(51) Int. Cl. H05B 33/14

(52) U.S. Cl. 428/690; 428/917; 313/504

(57) ABSTRACT

An organic EL device, includes an anode, cathode, and at least one organic luminescent layer including a compound of the formula:

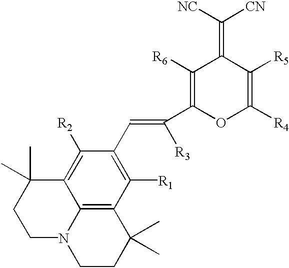

Where

R1 and R2 are individually an alky and alkoxy group containing from 1 to 10 carbon atoms, aryl, carbocyclic, heterocyclic systems and halogens; R3 is hydrogen or an alkyl group containing 1 to 10 carbon atoms, a branched and unbranched 5 to 6 member substituent carbocyclic and heterocyclic ring connecting with R1 or R2; R4 is an alkyl group containing from 1 to 20 carbon atoms; sterically hindered aryl and heteroaryl; perhaloalkyl of 1-10 carbon atoms; R5 is an alkyl group containing from 1 to 10 carbon atoms, a 5 or 6-member carbocyclic ring connecting with R4 and halides; and R6 is halides.

### FIELD OF THE INVENTION

This invention relates to organic electroluminescent (EL) devices. More specifically, this invention relates to the use of a novel class of luminescent materials for efficiently producing red light emission.

### BACKGROUND OF THE INVENTION

Organic light-emitting devices (OLEDs) have received considerable attention due to their potential applications in flat-panel display. For full-color applications, it is necessary to have a set of red, green and blue emitters with sufficiently high luminous efficiency and proper chromaticity. After one decade of intensive research, organic materials for green and blue OLEDs with high luminance, high efficiency, saturated emission and practical lifetime have been developed. However, the corresponding development of organic materials for red electroluminescence (EL) lags significantly behind that for the other two primary colors. Presently, most high-performance red OLEDs are made by doping a red dye into a suitable host. The reported dopants include pyran-containing compounds, porphyrin compounds and europium chelate complexes. While saturated red emissions have been obtained from the porphyrin compounds and europium chelates complexes, the luminescent efficiency of most of them is unacceptably low. The most promising red dopant among the porphyrin compounds and europium chelates complexes for OLED is platinum octaethylporphyrin (PtOEP), the phosphorescent quantum yield of which is about 0.45. Although the devices with PtOEP doped into tris(8-quinolinolato) aluminum (AIQ) show higher efficiencies at a low injection current, the efficiency and chromaticity of the devices at higher injection current densities are not practicable. The pyran-containing compounds, such as DCM, DCM2, DCJT and DCJTB, have been widely studied and are regarded as important red-dopants for OLED applications (U.S. Pat. No. 5,908,581 by C. H. Chen et al). However, their performance as red emitters is still significantly inferior to that of the prototypical green and blue emitters. In particular, color saturation is far from ideal. This problem of color purity is partly due to the fact that the PL peaks of these compounds are in the range of 590 to 615 nm. A significant portion of their emission spectra is in fact below 600 nm, and thus they cannot give emit a saturated red color. Inefficient energy transfer from the typical host materials, such as AIQ, also contributes to the unsaturated emission. The latter cause may be remedied by using a second dopant material as a bridge to assist energy transfer from the host, or by using another host material with its emission energy closer to the absorption peaks of the red dopants. On the other hand, the emission peaks of the dopants have to be shifted further to the long wavelength side, so that the emission below 600 nm can be substantially reduced. In addition, synthetic procedures for some of these compounds are rather complicated and would significantly increase the production cost for red OLEDs. There still remains much room for improvement in the materials for red OLEDs. It is an objective of the present invention to provide an organic EL device that efficiently produces red light emissions.

### SUMMARY OF THE INVENTION

In the present invention, it has been found that one class of novel luminescent materials is capable of producing highly efficient red electroluminescence. These materials can be used as a dopant to produce EL devices. The above objective is achieved in an organic EL device, comprising an anode, cathode, and at least one organic luminescent layer including a compound of formula:

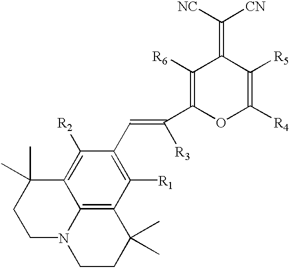

Where

R1 and R2 are individually an alkyl and alkoxyl group of 1 to 10 carbon atoms, aryl, carbocyclic, heterocyclic systems and halogens. R3 is an alkyl group of 1 to 10 carbon atoms, a branched or unbranched 5 to 6 member substituent carbocyclic and heterocyclic ring connecting with R1 or R2. R4 is an alkyl group of 1 to 20 carbon atoms, sterically hindered aryl and heteroaryl group. R5 is an alkyl group of 1 to 10 carbon atoms, a 5 to 6-member carbocyclic ring connecting with R4, and halide. R6 is a halide.

It is an advantage of the present invention that the claimed organic luminescent materials can be highly effective in producing red light emissions with good chromaticity when used in organic EL devices.

### BRIEF DESCRIPTION OF THE DRAWINGS

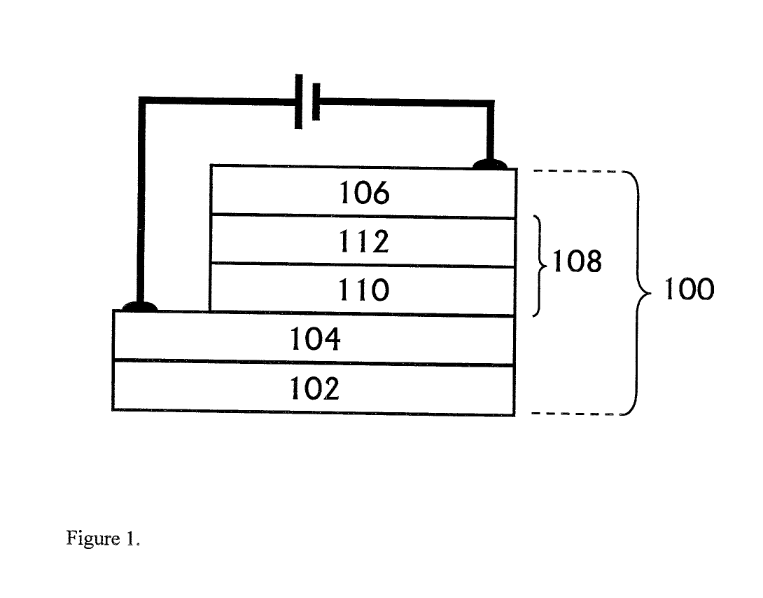

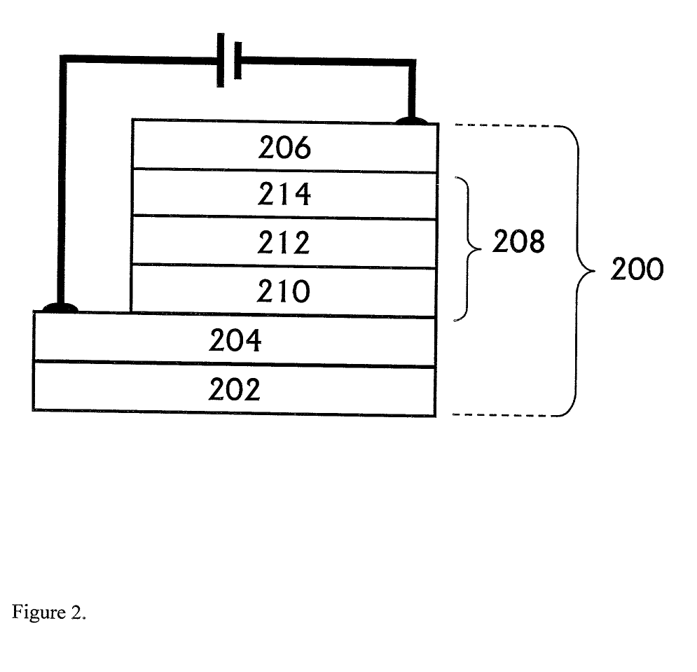

These and other advantages of this invention can be better appreciated by reference to the following detailed description considered in conjunction with the drawings in which: FIGS. 1 and 2 are schematic diagrams of the multi-layer structures of preferred EL devices in accordance with the present invention.

### DETAILED DESCRIPTION OF THE PREFERRED EMBODIMENTS

An EL device 100 according to the invention is schematically illustrated in FIG. 1. The support is layer 102, which is an electrically insulating and optically transparent material such as glass or plastic. Anode 104 is separated from cathode 106 by an organic EL medium 108, which, as shown, consists of two superimposed layers of organic thin films. Layer 110 located on the anode forms a hole-transport layer of the organic EL medium. Located above the hole-transport layer is layer 112, which forms an electron-transport layer of the organic EL medium.

When the anode is at a higher potential than the cathode, holes (positive charge carriers) are injected from the anode into the hole-transport layer, and electrons are injected into the electron-transport layer. The injected holes and electrons each migrate toward the oppositely charged electrode. This results in hole-electron recombination and a release of energy in part as light, thus producing electroluminescence.

Organic EL device 200 shown in FIG. 2 is illustrative of another preferred embodiment of the invention. The insulating and transparent support is layer 202. The anode 204 is separated from the cathode 206 by an EL medium 208, which, as shown, consists of three superimposed layers of organic thin films. Layer 210 adjacent to anode 204 is the hole-transport layer. Layer 214 adjacent to cathode 206 is the electron-transport layer. Layer 212 that is in between the hole-transport layer and the electron transport layer is the luminescent layer. This luminescent layer also serves as the recombination layer where the hole and electron recombines.

The configurations of devices 100 and 200 are similar, except that an additional luminescent layer is introduced in device 200 to function primarily as the site for hole-electron recombination and thus electroluminescence.

The substrate for the EL devices 100 and 200 is electrically insulating and light transparent. The light transparent property is desirable for viewing the EL emission through the substrate. For applications where the EL emission is viewed through the top electrode, the transmissive characteristic of the support is immaterial, and therefore any appropriate substrate such as opaque semiconductor and ceramic wafers can be used. Of course, it is necessary to provide in these device configurations a light transparent top electrode.

The composition of the organic EL medium is described as follows, with particular reference to device structure 200.

The hole transporting layer of the organic EL device contains at least one hole transporting aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monarylamine, diarylamine, triarylamine, or a polymeric arylamine.

The luminescent layer of the organic EL device comprises of a luminescent or fluorescent material, where electroluminescence is produced as a result of electron-hole pair recombination in this region. In the simplest construction, the luminescent layer comprises of a single component, which is a pure material with a high fluorescent efficiency. Particularly preferred thin film forming materials for use in forming the luminescent layers of the organic light-emitting device 100 are metal chelated oxinoid compounds, including chelates of oxine itself (also commonly referred to as 8-quinolinol or 8-hydroxyquinoline). Such compounds exhibit high levels of performance and are readily fabricated in the form of thin films. Exemplary samples of contemplated oxinoid compounds are those satisfying structural formula (V): (V)

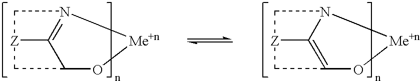

wherein

Me represents a metal,

n is an integer of from 1 to 3, and

Z independently in each occurrence represents the atoms completing a nucleus having at least two fused aromatic rings.

From the foregoing it is apparent that the metal can be monovalent, divalerit, or trivalent metal. The metal can, for example, be an alkali metal, such as lithium, sodium, or potassium; an alkaline earth metal, such as magnesium or calcium; or a regular metal, such as boron or aluminum. Generally any monovalent, divalent, or trivalent metal known to be a useful chelating metal can be employed. A well-known material is tris(8-quinolinato) aluminum, (Alq), which produces excellent green electroluminescence.

A preferred embodiment of the luminescent layer comprises a multi-component material consisting of a host material doped with one or more components of fluorescent dyes. Using this method, highly efficient EL devices can be constructed Simultaneously, the color of the EL devices can be tuned by using fluorescent dyes of different emission wavelengths in a common host material. An important relationship for choosing a fluorescent dye as a dopant capable of modifying the hue of light emission when present in a host material is a comparison of their bandgap energy, which is defined as the energy difference between the highest occupied molecular orbital and the lowest unoccupied molecular orbital of the molecule. For efficient energy transfer from the host to the dopant molecule, a necessary condition is that the bandgap of the dopant is smaller than that of the host material

In the practice of the present invention, the host material forming the EL luminescent layer where light is emitted in response to electron-hole recombination is selected from the group of metal chelated oxinoid compounds, including: Aluminum trisoxine (Alq3), Gallium trisoxine (Gaq3), Indium trisoxine (Inq3), Magnesium bisoxine (Mgq2), and Lithium oxine (Liq). Efficient blue electroluminescent materials can also be used as a host because their bandgap is substantially greater than that of the dopant materials disclosed in this invention.

In the present invention, it has been found that a class of novel luminescent materials is capable of producing highly efficient red electroluminescence, and can readily be used as a dopant to produce EL devices. The material is a compound of formula:

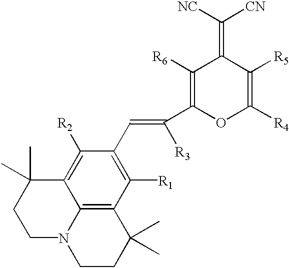

Where

R1 and R2 are individually an alkyl and alkoxyl group containing 1 to 10 carbon atoms, aryl, carbocyclic, heterocyclic systems and halides; R3 is hydrogen or an alkyl group containing 1 to 10 carbon atoms, a branched and unbranched 5 to 6 member substituent carbocyclic and heterocyclic ring connecting with R1 or R2; R4 is an alkyl group of 1 to 20 carbon atoms, sterically hindered aryl and heteroaryl; perhaloalkyl of 1-10 carbon atoms; R5 is an alkyl group of 1 to 10 carbon atoms, a 5 or 6-member carbocyclic ring connecting with R4 and halides; and R6 is a halide. The term “sterially hindered” n moiety that restricts free rotation about a C—C single bond.

In the above compound R1 and R2 can be methyl, ethyl, propyl, n-butyl, methoxy, ethoxy, propoxy, isopropoxy, n-butoxy, I-butoxy, t-butoxy, aryl, carbocyclic, heterocyclic systems, including phenyl and furyl, thienyl pyridyl; R3 is alkyl of 1 to 10 carbon atoms, a branched or unbranched 5 to 6- member substituent carbocyclic and heterocyclic connecting with R1 or R2. R4 is methyl, ethyl, propyl, n-butyl, i-propyl, t-butyl, sec-butyl, t-amyl, neopentyl and the like; sterically hindered aryl, for example, 1- naphthyl, 9-anthracenyl, pyrenyl perylenyl, ortho-substituented aryl of 1-10 carbon atoms, including mesityl, 2,4-dimethylphenyl, 2-methylphenyl and the like; perhaloalyl of 1-10 carbon atoms, including trifluoromethyl, pentafluoroethyl, perfluoroalkyl and wherein when the carbocyclic ring is connected with R5. It forms the following structure R4,R5=(—CH2CH2CH2—), (—CH2CH═CH—) and (—CH2CH2CH2CH2—), (—CH═CH—CH═CH—); R5 is alkyl of from 1 to 10 carbon atoms, a 5 or 6-member carbocyclic ring connecting with R4, and halides. R6 is fluorine, chlorine, bromine and iodine.

Preferred materials for use in forming the electron-transporting layer of the organic EL devices of this invention are metal chelated oxinoid compounds, including chelates of oxine itself (also commonly referred to as 8-quinolinol or 8-hydroxyquinoline). Such compounds exhibit high levels of performance and are readily fabricated in the form of thin layers.

The anode and cathode of the organic EL device can each take up any convenient conventional form. Where it is intended to transmit light from the organic EL device through the anode, this can be conveniently achieved by coating a thin conductive layer onto a light transparent substrate-e.g., a transparent or substantially transparent glass plate or plastic film. In one form, the organic EL devices of this invention can follow the historical practice of including a light transparent anode formed of tin oxide or indium tin oxide.

The organic EL devices of this invention can employ a cathode constructed of any metal having a work function lower than 4.0 eV, such as calcium and lithium. The cathode can also be formed through alloying a low work function metal with a high work function metal. A bilayer structure of Al/LiF can also be used to enhance electron injection, as disclosed in U.S. Pat. No. 5,624,604 by Hung et al.

The preferred materials for the multi-layers of the organic EL medium are each capable of film-forming; that is, capable of being fabricated as a continuous layer having a thickness of less than 5000 Å. A preferred method for forming the organic EL medium is by vacuum vapor deposition. Extremely thin defect-free continuous layers can be formed by this method. Specifically, the individual layer thickness as low as about 50 Å can be constructed while still realizing satisfactory EL device performance. It is generally preferred that the overall thickness of the organic EL medium be at least about 1000 Å.

Other methods for forming thin films in EL devices of this invention include spin-coating from a solution containing the EL material. A combination of spin-coating method and vacuum vapor deposition method is also useful for the fabrication of multi-layer EL devices.

### EXAMPLES

The invention and its advantages are further illustrated by the specific examples as follows:

Materials preparations—Synthesis of 4-(dicyanomethylene)-2-t-butyl-6-(8-methoxy-1,1,7,7-tetramethyljulolidyl-9-enyl)-4H-pyran (DCJMTB)

### Example 1

### Synthesis of 4-(dicyanomethylene)-2-methyl-4H-pyran Derivatives (5)

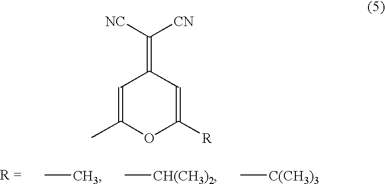

R=—CH₃, —CH(CH₃)₂, —C(CH₃)₃

The Compound (R=t-butyl) was synthesized according to the U.S. Pat. No. 5,908,581 by C H Chen et al.

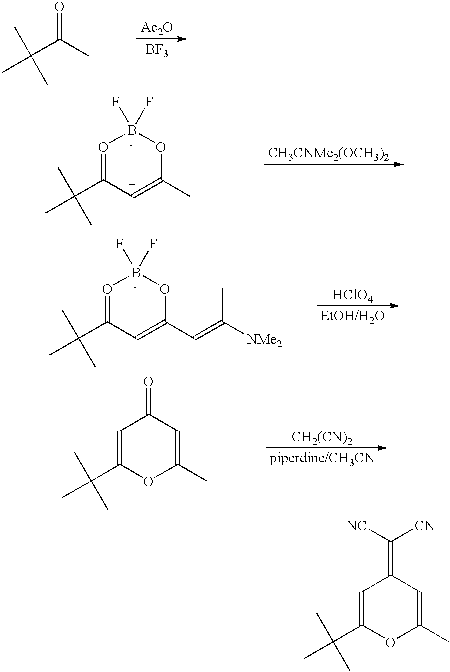

### Example 2

### Synthesis of 8-methoxy-1,1,7,7-tetramethyllulolidine-9-carboxaldehyde (6)

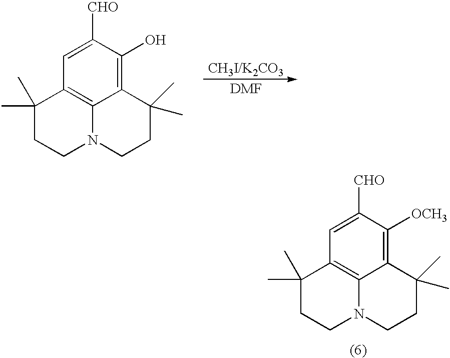

1 gm of 8-hydroxy-1,1,7,7-tetramethyljulolidine-9-carboxaldehyde, 0.6 gm of K₂CO₃ in 10 ml of DMF, 0.23 ml of CH₃I was added to the solution at room temperature. The reaction mixture was stirred for 6 h, then poured into 30 ml-water. The precipitate was filtered, washed with cold water, and dried to give a light yellow solid containing yield 95% of the compound (6).

### Example 3

### Synthesis of DCJMTB (R=t-Bu)

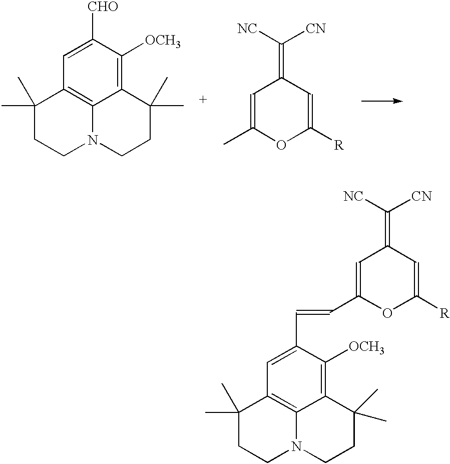

A solution of 0.012 mol of 4-(dicyanomethylene)-2-(t-butyl)-6-methyl-4H 4H-pyran (R=t-Bu), 0.012 mol of 8-hydroxy-1,1,7,7-tetramethyljulolidine-9-carboxaldehyde and 0.36 ml of piperidine in 30 ml of acetonitrile was refluxed under nitrogen for overnight. On cooling, the precipitated dye was filtered and washed with acetonitrile to give a solid containing 99% pure DCJTMB. Mass spectrum: m/e 438 (M⁺ for C₃₁H₃₇N₃O₂). ¹HNMR(300 MHz, CDCl₃) δppm: 7.6(d, 1H), 7.3 (br, 2H), 6.5 (m, 2H), 3.8 (s, 3H), 3.3 (dt, 4H), 1.7 (t,4H), 1.4 (s, 6H), 1.36 (s, 9H), 1.3 (s, 6H).

Device Preparation and Characterization

### Example 4

An EL device satisfying the requirements of the invention was constructed in the following manner. The organic EL medium has four organic layers, namely, a hole transport layer, a luminescent layer, and an electron-transport layer

a) An indium-tin-oxide (ITO) coated glass substrate was sequentially ultrasonicated in a commercial detergent, rinsed in deionized water, degreased in toluene vapor and exposed to ultraviolet light and ozone for a few minutes.

b) Onto the ITO anode was deposited a hole transport layer (800 Angstroms) of N,N′-diphenyl-N,N′-(3-methylphenyl)-1,1′-biphenyl-4,4′-diamine (TPD) by evaporation from a tantalum boat.

c) A luminescent layer of 4-(dicyanomethylene)-2-t-butyl-6-(8-methoxy-1,1,7,7-tetramethyljulolidyl-9-enyl)-4H-pyran (DCJMTB) from example 3 (600 Angstroms) was then deposited onto the hole-transport layer by evaporation from a tantalum boat.

d) An electron-transport layer of Alq (200 Angstroms) was then deposited onto the luminescent layer by evaporation from a tantalum boat.

e) On top of the Alq layer was deposited by evaporation a cathode layer (2000 Angstroms) formed of a 10:1 atomic ratio of Mg and Ag.

The light output peaked at 648 nm with CIE color coordinates of X=0.67 and Y=0.33.

### Example 5

An EL device satisfying the requirements of the invention was constructed in the following manner. The organic EL medium has four organic layers, namely, a hole transport layer, a luminescent layer, and an electron-transport layer

a) An indium tin oxide (ITO) coated glass substrate was sequentially ultrasonicated in a commercial detergent, rinsed in deionized water, degreased in toluene vapor and exposed to ultraviolet light and ozone for a few minutes.

b) Onto the ITO anode was deposited a hole transport layer (800 Angstroms) of N,N′-diphenyl-N,N′-(3-methylphenyl)-1,1′-biphenyl-4,4′-diamine (TPD) by evaporation from a tantalum boat.

c) A luminescent layer of DCJMTB-doped Alq (600 Angstroms) with a dopant concentration varied from 1% to 3% was then deposited onto the hole-transport layer by evaporation from a tantalum boat.

d) An electron-transport layer of Alq (200 Angstroms) was then deposited onto the luminescent layer by evaporation from a tantalum boat.

e) On top of the Alq layer was deposited by evaporation a cathode layer (2000 Angstroms) formed of a 10:1 atomic ratio of Mg and Ag.

The light output from this EL device at a dopant concentration of 1% peaked at 620 nm with a luminance efficiency of 2.8 cd/A. The light output from this EL device at a dopant concentration of 3% peaked at 640 nm with a luminance efficiency of 0.82 cd/A.

### Example 6

An EL device satisfying the requirements of the invention was constructed in the following manner. The organic EL medium has three organic layers, namely, a hole transport layer, a luminescent layer, and an electron-transport layer

a) An indium tin -oxide (ITO) coated glass substrate was sequentially ultrasonicated in a commercial detergent, rinsed in deionized water, degreased in toluene vapor and exposed to ultraviolet light and ozone for a few minutes.

b) Onto the ITO anode was deposited a hole transport layer (800 Angstroms) of N,N′-diphenyl-N,N′-(3-methylphenyl)-1,1′-biphenyl-4,4′-diamine (TPD) by evaporation from a tantalum boat.

c) A luminescent layer of DCJMTB-doped GaQ (600 Angstroms) with a dopant concentration varied from 1% to 3% was then deposited onto the hole-transport layer by evaporation from a tantalum boat.

d) An electron-transport layer of Alq (200 Angstroms) was then deposited onto the luminescent layer by evaporation from a tantalum boat

e) On top of the Alq layer was deposited by evaporation a cathode layer (2000 Angstroms) formed of a 10:1 atomic ratio of Mg and Ag.

The light output from this EL device at a dopant concentration of 1% peaked at 624 with CIE color coordinates of X=0.66 and Y=0.33 and had a luminance efficiency of 2.64 cd/A. The light output from this EL device at a dopant concentration of 3% peaked at 644 nm with CIE color coordinates of X=0.63 and Y=0.36 and had a luminance efficiency of 1.64 cd/A.

The invention has been described in detail with particular reference to certain preferred embodiments thereof, but it will be understood that variations and modifications can be effected within the spirit and scope of the invention. For example, the organic luminescent material included at least one of the layers of the device can be a mixture of the luminescent organic metallic complex and other fluorescent materials.

What is claimed is:

1. An organic EL device, comprising an anode, cathode, and at least one organic luminescent layer including a compound of the formula: 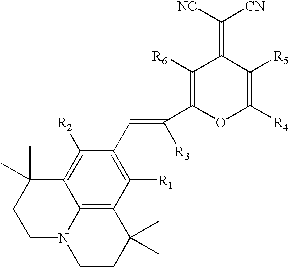
Where
R1 and R2 are individually an alky and alkoxy group of 1 to 10 carbon atoms, aryl, carbocyclic, hetercyclic systems and halides;
R3 is hydrogen or an alkyl group of 1 to 10 carbon atoms, a branched and unbranched 5 to 6 member substituent carbocyclic and heterocyclic ring connecting with R1 or R2;
R4 is an alkyl group of 1 to 20 carbon atoms; sterically hindered aryl and heteroaryl; perhaloalkyl of 1-10 carbon atoms;
R5 is an alkyl group of 1 to 10 carbon atoms, a 5 or 6-member carbocyclic ring connecting with R4 and halide; and
R6 is halide.
The term “sterially hindered” means a function moiety that restricts free rotation about a C—C single bond.

2. The organic EL device according to claim 1, wherein in the above compound R1 and R2 can be methyl, ethyl, propyl, n-butyl, methoxy, ethoxy, propoxy, isopropoxy, n-butoxy, I-butoxy, t-butoxy, aryl, carocyclic, heterocyclic systems, including phenyl and furyl, thienyl pyridyl;

3. The organic EL device according to claim 1 wherein R3 is an alkyl group of 1 to 10 carbon atoms, a branched or unbranched 5 to 6-member substituent carbocyclic and heterocyclic connecting with R1 or R2.

4. The organic EL device according to claim 1 wherein R4 is methyl, ethyl, propyl, n-butyl, I-propyl, t-butyl, sec-butyl, t-amyl, neopentyl and like; sterically hindered aryl, for example, 1-naphthyl, 9-anthracenyl, pyrenyl perylenyl, ortho-substituented aryl of 1-10 carbon atoms, including mesityl, 2,4-dimethylphenyl, 2-methylphenyl and the like; perhaloalyl of from 1-10 carbon atoms, including trifluoromethyl, pentafluoroethyl, perfluoroalkyl and wherein when the carbocyclic ring is connected with R5. It forms the following structure R4, R5=(—CH2CH2CH2—), (—CH2CH═CH—) and (—CH2CH2CH2CH2—), (—CH═CH—CH═CH—);

5. The organic EL device according to claim 1 wherein R5 is an alkyl group of 1 to 10 carbon atoms, a 5 or 6-member carbocyclic ring connecting with R4, and halide.

6. The organic EL device according to claim 1 wherein R6 is fluorine, chlorine, bromine and iodine.
